(19) United States
(12) Patent Application Publication
(10) Pub. No.: US 2008/0126446 A1
(43) Pub. Date: May 29, 2008

(54) Systems and methods for backing up user settings

(75) Inventors: Jeffrey Brunet, Richmond Hill (CA); Ian Collins, Markham (CA); Yousuf Chowdhary, Maple (CA)

Correspondence Address: CARR & FERRELL LLP, 2200 GENG ROAD, PALO ALTO, CA, 94303, US

(73) Assignee: Storage Appliance Corporation

(21) Appl. No.: 11/998,096

(22) Filed: Nov. 27, 2007

Related U.S. Application Data
(60) Provisional application No. 60/860,919, filed on Nov. 27, 2006.

(51) Int. Cl. G06F 17/00

(52) U.S. Cl. 707/204

(57) ABSTRACT

Systems and methods are provided for backing up the user settings of a computing system. The computing system is searched to identify an installed application, a known pathname for a user setting of the identified application is then obtained, and then the user setting is backed up by using the specified pathname to find the user setting on the computing system. User settings can be backed up for one or more user accounts of the computing system, and later the user settings for any of the backed up user accounts can be restored to the computing system, or copied to another computing system. In this way, a user's customization of the computing system can be restored to the computing system at a later time or provided to another computing system.

### CROSS-REFERENCE TO RELATED APPLICATIONS

This application claims the benefit of U.S. Provisional Patent Application No. 60/860,919 filed on Nov. 27, 2007 and entitled “A Method and System for the Automatic Backup of Computer Settings and User Preferences and the Restoration of the Same.” This application is related to U.S. patent application Ser. No. 11/506,386 filed on Aug. 18, 2006 and entitled “Data Backup Devices and Methods for Backing up Data” which is a divisional application of U.S. patent application Ser. No. 11/492,380 filed on Jul. 24, 2006 and entitled “Emulation Component for Data Backup Applications.” This application is also related to U.S. patent application Ser. No. 11/546,176 filed on Oct. 10, 2006 and entitled “Optical Disc Initiated Data Backup.” This application is also related to U.S. patent application Ser. No. 11/601,040 filed on Nov. 16, 2006 and entitled “Methods for Selectively Copying Data Files to, Networked Storage and Devices for Initiating the Same” which is also a Continuation-in-Part of U.S. patent application Ser. Nos. 11/506,386 and 11/546,176. Each of the aforementioned applications is incorporated herein by reference.

### BACKGROUND OF THE INVENTION

1. Field of the Invention

The present invention relates generally to the field of backing up digital content and more particularly to preserving user settings.

2. Description of the Prior Art

Many backup systems in the marketplace today are tedious to use. These systems typically require installation and configuration by the user and then execute a backup process that can run for hours. Some backup systems completely replicate the contents of an entire logical storage area, while others selectively back up data. For example, some backup systems are specific to a particular application, such as backing up data for accounting software, and otherwise ignore all other applications. Other backup systems back up data, for example, by finding those files that have certain file extensions or that are stored in a particular folder.

One popular example, the Microsoft File and Transfer Wizard creates a single monolithic file that requires substantial storage capacity, and ignores non-Microsoft products. Should a sector of the storage medium become bad after a time, the entire monolithic file may become useless.

### SUMMARY

An exemplary method of the invention comprises searching a computing system to identify an application installed on the computing system, obtaining a specified pathname for a user setting of the identified application, and backing up the user setting of the identified application using the specified pathname. Obtaining the specified pathname can comprise, in some embodiments, accessing a look-up table that associates, for known applications, the known pathnames for the user settings of those applications. Backing up the user setting can include storing the user setting to a backup device, or storing the user setting to networked storage.

In some embodiments, the method further comprises restoring to the computing system the backed up user setting using the specified pathname. The method can further comprise copying the user setting to another computing system. Additionally, the method can further comprise receiving a selection of a user account and backing up the user setting includes using the selected user account. The method can further comprise obtaining a specified pathname for a user setting associated with an operating system of the computing system and backing up the user setting associated with the operating system. The method can also comprise obtaining a defined data field or a pathname for a Windows Registry key for a user setting of an operating system of the computing system and backing up the Windows Registry key of the user setting of the operating system using the defined data field or pathname for the Windows Registry key.

Another exemplary method of the invention comprises searching a computing system to identify an application installed on the computing system, obtaining a specified file extension for a user setting of the identified application, and backing up the user setting of the identified application using the specified file extension. In some embodiments, backing up the user setting includes storing an indication of a location of the user setting within a directory structure of the computing system.

The present invention also provides a computer readable medium having stored thereupon computing instructions. The computing instructions comprise a code segment to search a computing system to identify an application installed on the computing system, a code segment to obtain a specified pathname for a user setting of the identified application, and a code segment to back up the user setting of the identified application using the specified pathname.

An exemplary backup device of the present invention comprises a computer readable medium having stored thereupon computing instructions. The computing instructions include a code segment to search a computing system to identify an application installed on the computing system, a code segment to obtain a specified pathname for a user setting of the identified application, and a code segment to back up the user setting of the identified application using the specified pathname. In some embodiments, the code segment to back up the user setting is configured to back up the user setting to the computer readable medium. In various embodiments the computer readable medium can comprise a hard disk, an optical disc, or a flash memory. The backup device can further comprise an emulation component, in some embodiments.

### BRIEF DESCRIPTION OF DRAWINGS

FIG. 1 shows user settings of a computing system being backed up to a backup device and then being restored to the computing system according to an embodiment of the present invention.

FIG. 2 shows user settings of a computing system being backed up to a backup device and then being copied to another computing system according to an embodiment of the present invention.

FIG. 3 shows a flowchart representation of a method for backing up user settings and restoring/copying the user settings to a computing system, according to an embodiment of the present invention.

FIG. 4 shows a directory structure of the computing system of FIG. 1 according to an embodiment of the present invention.

FIG. 5 shows a flowchart representation of a method for backing up user settings for a specified user account, according to an embodiment of the present invention.

FIG. 6 shows a backup device according to an embodiment of the present invention.

FIG. 7 shows a backup device according to another embodiment of the present invention.

FIG. 8 shows a backup device according to another embodiment of the present invention.

FIG. 9 shows a computing system with an internal optical drive and an attached external optical drive for receiving the backup device of FIG. 8 according to an embodiment of the present invention.

FIG. 10 shows a backup device according to another embodiment of the present invention.

### DETAILED DESCRIPTION OF THE INVENTION

The present invention is directed to systems and methods for backing up user settings of a computing system. User settings encompass those user-customizations and personalizations saved by an application or an operating system. User settings are distinguished from user data that encompasses the data files that a user creates or produces when using an application, such as spreadsheets, text documents, audio and video files, presentations, and the like. By backing up the user settings of the computing system, these user-customizations can be restored to the computing system at a later time. Additionally, the user settings can be copied to another computing system so that the operating system and/or the applications of the second computing system have the same user-customizations as the first computing system.

The systems and methods of the present invention can be used, for instance, to augment other backup applications that do not otherwise seek to preserve these user-customizations. In particular, the systems and methods of the present invention can be used in conjunction with the backup systems and methods disclosed in the several related applications listed above.

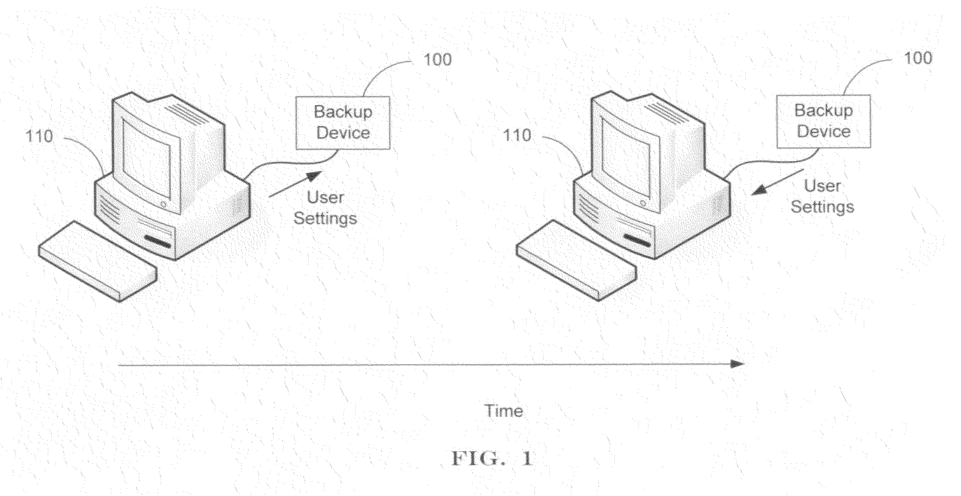

FIG. 1 shows user settings of a computing system being backed up to a backup device and then being restored to the computing system according to an embodiment of the present invention. In FIG. 1 a backup device 100 is coupled to a computing system 110 and user settings are backed up from the computing system 110 to the backup device 100. Various examples of the backup device 110 are described in greater detail elsewhere herein. The computing system 110, as used herein, can be any system comprising a processor and memory and is not limited to a computer such as a desktop or laptop unit. Accordingly, computing system 110 can include other electronic systems and devices such as automobile navigation systems and video game consoles.

At a later point in time the user settings can be stored back to the computing system 110 from the backup device 100 thus restoring the user settings of the computing system 110. A user might seek to restore the user settings to the computing system 110 following the accidental modification of the user settings as well as after the loss of the user settings from the computing system 110 due to a computer virus or other malicious attack. It will be understood that the backup device 100 does not need to remain connected to the computing system 110 during the period between backing up the user settings and later restoring the user settings to the computing system 110.

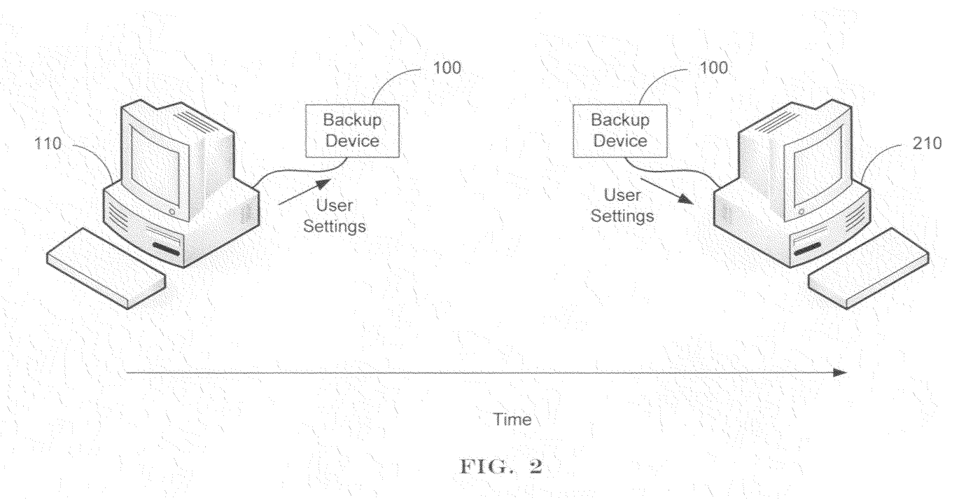

Another aspect of the invention is illustrated generally by FIG. 2. Here, the backup device 100 is coupled to the computing system 110 and the user settings are backed up from the computing system 110 to the backup device 100. Subsequently, the user settings can be copied to another computing system 210 to configure the computing system 210 with the user settings of the computing system 110.

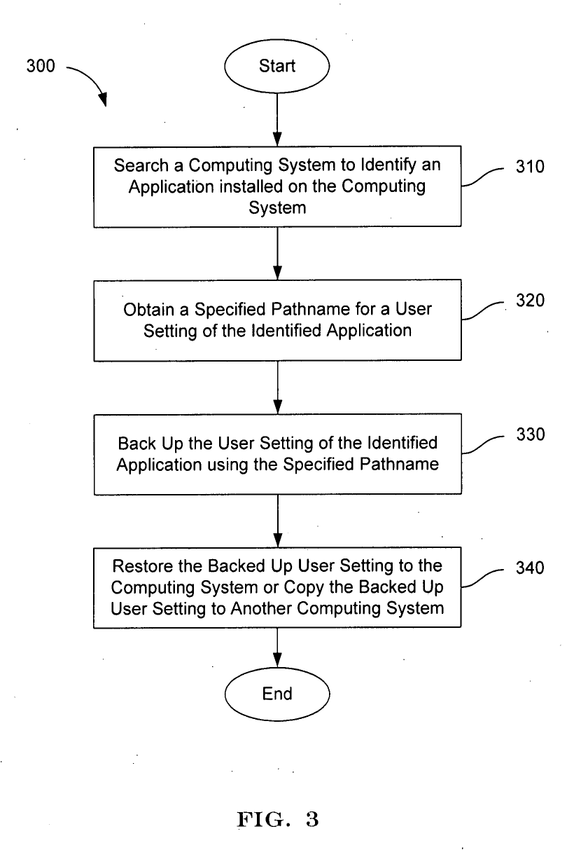

FIG. 3 shows a flowchart representation of an exemplary method 300 for backing up a user setting and then optionally restoring the user setting to the same computing system or copying the user setting to another computing system. The method 300 can be performed, for example, by logic of the computing system 110 (FIG. 1) such as software, firmware, hardware or a combination thereof. As one example, the method 300 can be performed by software comprising a backup application such as described in the various applications listed herein as related applications. Method 300 comprises searching 310 a computing system to identify an application installed on the computing system, obtaining 320 a specified pathname for a user setting of the identified application, and backing up 330 the user setting of the identified application using the specified pathname. The method 300 optionally comprises restoring/copying 340 the user setting to either the same or another computing system. The method 300 can further comprise additional optional steps discussed below.

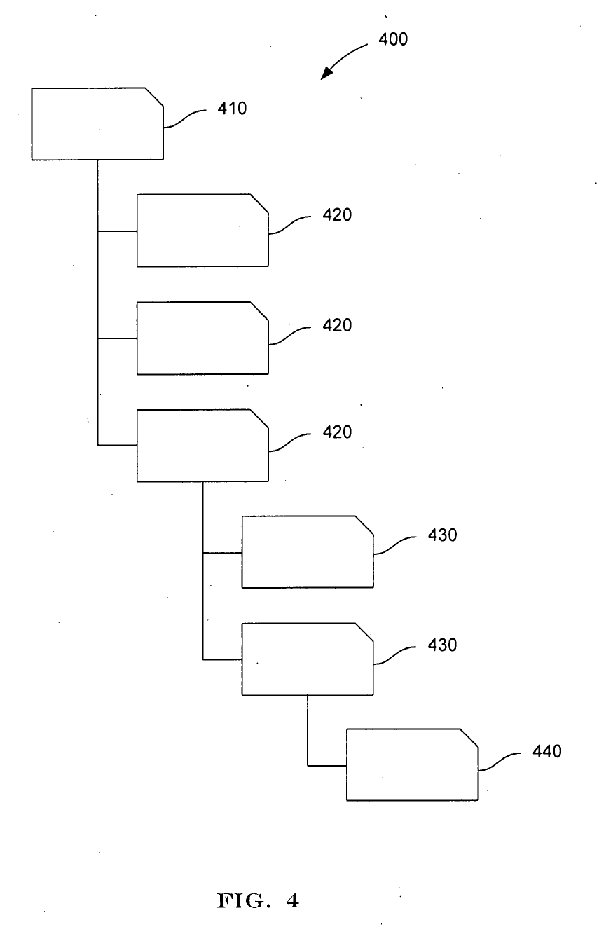

Searching 310 the computing system (e.g., computing system 110 of FIG. 1) to identify an application installed on the computing system can include, for example, searching a directory structure of the computing system. FIG. 4 schematically illustrates an exemplary directory structure 400 of the computing system in which folders 410, 420 430, and 440 are arranged in a hierarchical structure. Searching 310 the computing system to identify an application can comprise limiting the search to those folders known to include applications, such as C:\program_files. Examples of applications include Internet Explorer, Mozilla Firefox, Mozilla Thunderbird e-mail client, ICQ, AIM, Yahoo! Messenger, Yahoo! Toolbar, Google Toolbar, Google Picasa, Skype, WinZip, Microsoft Word, Microsoft Outlook, and software plug-ins like Java, Shockwave, Flash, Quicktime, RealPlayer, and Windows Media Player, among many other possibilities.

Once an installed application has been identified, the method 300 continues by obtaining 320 a specified pathname for a user setting of the identified application. The location of a file containing the user setting within the directory structure 400 can be specified by a pathname such as C:\program_files\program_name\user_settings.doc. Here, for example, a look-up table can be accessed to determine the known pathname of the user setting for the identified application. It will be appreciated that accessing a look-up table is merely one example of the various ways one can obtain a known pathname for a user setting of a known application, any of which can be a suitable alternative to accessing the look-up table.

An exemplary look-up table contains a rule set for each listed application and operating system. The rule set specifies where to find various user settings, such as a particular folder of the directory structure, a particular folder in the Windows Registry, or both. As one example, a rule set for an application called Skype would indicate that user settings can be found in a folder with a pathname of C:\Documents and Settings\UserName\Application Data\Skype in a file named config.xml and in other files with the .lck file extension. The rule set would also show that other user settings are saved in the Windows Registry (e.g., the setting for “Default Language”) and would provide a defined data field or pathname for these user settings as well.

The look-up table can be stored on a backup device (e.g., backup device 100 of FIG. 1) or a server that can be accessed across a network such as the Internet. From either of these sources the look-up table can be stored to the computing system. In any of these locations the look-up table can be updated periodically to reflect new applications, newer versions of known applications, and new rules for locating user settings. In those embodiments where the look-up table is located on the computing system, for example, the look-up table can be updated by a master look-up table over a network connection.

If the lookup table does not contain a rule set for an identified application, at least two alternatives exist. Where the look-up table is stored locally (i.e., on the computing system or backup device) and may not be up to date, the master look-up table can be consulted by making a network connection to a server that has access to the master look-up table. Alternately, or if consulting the master look-up table does not provide a rule set, the Windows Registry can be searched for the pathnames of the locations of the user settings.

Next, the method 300 comprises backing up 330 the user setting of the identified application using the specified pathname. For instance, the rule set of the look-up table can specify a pathname for a folder and a file extension for the particular file that includes the user setting. The user setting can therefore be located on the computing system and stored, for example, to a backup device or to a networked storage.

As noted previously, user settings encompass user-customizations and personalizations stored by an application or an operating system. Examples of user settings include bookmarks, template settings, local and regional settings, desktop settings such as background and screen savers, screen saver passwords and wait times, desktop icons including icon arrangement settings, display settings, power management settings, folder options, default fonts and associated options, Taskbar and Start Menu settings and configurations, Quick Launch Tool Bar settings and preferences, sound and audio settings, firewall and security settings, printer and facsimile settings, keyboard and mouse behavior settings, network, dialup, and modem settings, authentication settings, preferences, and tokens, share points, protocol settings, wireless network settings including Wired Equivalent Privacy (WEP) keys, preferred rules, customized dictionaries, playlists, macros, user account settings, multilingual user interface settings, time zone settings, web settings, consoles, cookies, offline websites, browser histories, off-line content, security certificates, personal information retained by AutoComplete and MyProfile, Internet browser advanced settings, etc.

The method 300 optionally comprises restoring/copying 340 the backed up user setting to the computing system or to another computing system (e.g., computing system 210 in FIG. 2). More specifically, restoring/copying 340 the backed up user setting comprises either restoring the user setting to the same computing system or copying the user setting to another computing system. In one example, the computing system to which the backed up user setting will be restored or copied is first searched to identify installed applications much as in searching 310. Next, for an identified application, a determination is made regarding whether the user setting for the identified application has been backed up. Where the user setting has been backed up for the identified application, the rule set for the application in the look-up table is consulted for the appropriate pathname for the user setting. Restoring/copying 340 the backed up user setting to the computing system can comprise overwriting an existing file or creating a new file at the location specified by the pathname. Restoring/copying 340 the backed up user setting to the computing system can also comprise updating a Windows Registry key.

Restoring/copying 340 the backed up user setting to the computing system can also comprise resolving differences between versions of an application or an operating system. For instance, the user setting of an application installed on a computer system running Windows XP can be backed up and then later restored or copied to a computing system running Windows Vista and having the same application installed. Mozilla FireFox, for example, running under Windows XP stores a user setting in a file with the .mfl file extension in a folder with one pathname. In Windows Vista the file extension is the same but the pathname for the folder is different. In this example, files with the file extension .mfl are located in the folder having the Vista pathname and overwritten with the backed up files from the computing system running Windows XP.

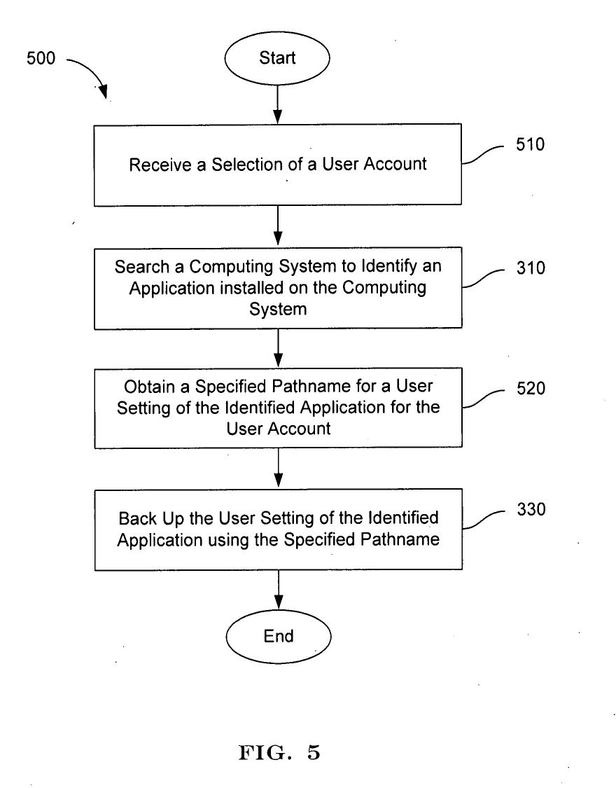

Some computing systems and applications support user accounts so that more than one user can maintain their own customizations of the operating system and applications. FIG. 5 shows a flowchart representation of a method 500 for backing up a user setting for a user account, according to an embodiment of the present invention. The method 500 comprises receiving 510 a user selection of a user account. For example, if more than one user account is found on the computing system, the user can be prompted to select one, several, or all user accounts.

Method 500 also comprises searching 310 (FIG. 3) a computing system to identify an application installed on the computing system. It will be appreciated that searching 310 the computer system and receiving 510 the user selection can be performed in either order. Method 500 also comprises obtaining 520 a specified pathname for a user setting of the identified application for the selected user account, and backing up 330 (FIG. 3) the user setting of the identified application using the specified pathname.

As in step 340 of method 300, method 500 can optionally comprise restoring the backed up user setting to the same computing system or copying the user setting to another computing system. In either case, the method can receive a user selection of a previously backed up user account in order to have the user setting of the selected user account restored to the same computing system or copied to another computing system. For instance, where a user setting for more than one user account was previously backed up, the user can be prompted to select the user account to restore to the same computing system or copy to another computing system.

If the name of the selected backed up user account does not exactly match any of the user accounts of the computing system that the backed up user setting is being restored or copied to, the user can be prompted to make a further selection between several options. One such option is to create a new user account based on the selected backed up user account. Another option is to overwrite the user setting of an existing user account on the computing system with the user settings of the selected backed up user account. A third option is to retain the backed up user setting on the backup device and neither overwrite the user setting of the existing user account nor create the new user account.

Additional steps can be included in both of the methods 300 and 500. For example, steps of the method 300 can also be applied to a user setting associated with an operating system of the computing system, as opposed to a user setting of an application as previously described. Thus, the methods 300 and 500 can comprise obtaining a specified pathname for the user setting of the operating system, backing up the user setting of the operating system using the specified pathname, and restoring the user setting to the same computing system or copying the user setting to another computing system, each in the same manner as steps 320, 330, and 340.

As another example, the user setting of an application or the operating system can be located in the Windows Registry rather than in a file within the directory structure. Thus, the methods 300 and 500 can comprise steps 320, 330, and 340 that utilize a defined data field or a pathname for a Windows Registry key for a user setting the application or of the operating system, rather than a pathname of a file within the directory structure.

As yet another example, the look-up table may associate a file extension with a user setting for an application, rather than a pathname. Therefore, the methods 300 and 500 can also comprise obtaining a specified file extension for the user setting of the identified application, and backing up the user setting of the identified application using the specified file extension.

Obtaining the specified file extension for the user setting of the identified application can be performed similarly to obtaining 320 (FIG. 3) the specified pathname. Backing up the user setting of the identified application using the specified file extension can also be performed similarly to backing up 330 (FIG. 3) the user setting by using the specified pathname. Here, the file extension can be used to locate a file that comprises the user setting for the identified application. In some embodiments, backing up the user setting includes backing up an indication of a location of the user setting within the directory structure of the computing system, such as a pathname. In this way, when the user setting is restored to the computing system, the user setting can be stored to the same location within the directory structure.

As just noted, where a file extension is utilized in place of a pathname, backing up the user setting can include backing up the indication of the location of the user setting within the directory structure. It will be appreciated that backing up 330 (FIG. 3) the user setting can also comprise backing up the indication of the location of the user setting even when the pathname is used as originally described. For example, where the pathname is obtained by accessing a look-up table from a server across a network connection, the look-up table may not be later available when subsequently restoring the user setting to the same computing system or copying the user setting to another computing system. By backing up an indication of the location, such as the pathname, in association with the user setting, the user setting can later be restored or copied without having to reference the look-up table.

It will be further appreciated that several alternatives can be employed to store the indication of the location of the user setting, other than to store the pathname. For instance, a portion of the directory structure of the computing system can be created and the user setting can be backed up to the corresponding location within the portion of the directory structure. As another example, a flat file structure with an XML index can be created to store the location information for later use.

As still another example of an optional step of the methods 300 and 500, backing up 330 the user setting of the identified application (or operating system) can be repeated following a change to the previously backed up user setting. Here, for example, the user setting is monitored after having been once backed up, and if the user setting is subsequently modified the user setting can be either immediately backed up again, or at least flagged to be backed up again as an incremental backup.

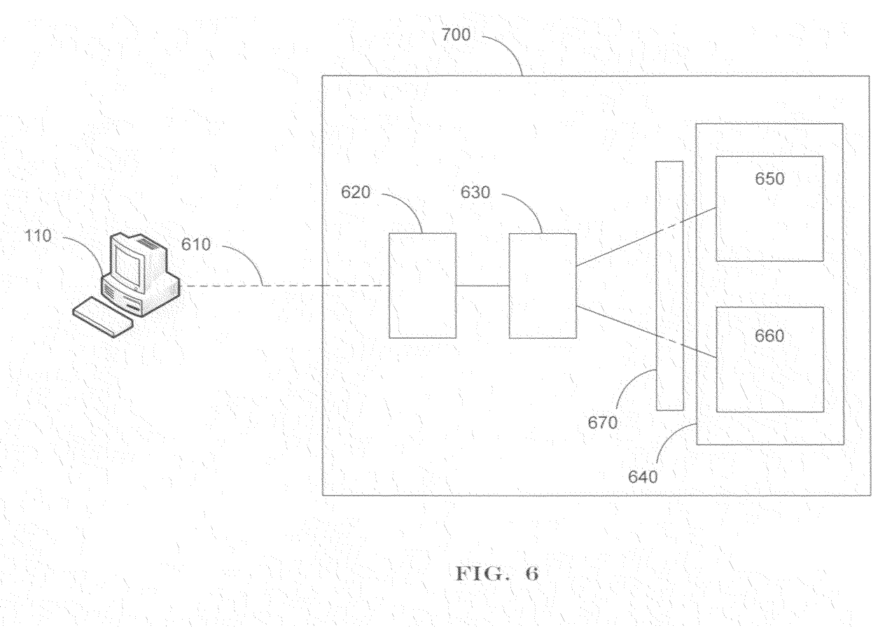

The present invention is also directed to a backup device 100 (FIG. 1) that can comprise a computer readable medium having stored thereon computing instructions for performing the various methods of the invention. Examples of different backup devices are described below with respect to FIGS. 6-8 and 10. FIG. 6 shows a schematic representation of an exemplary backup device 600 connected to a computing system 110 by a connection 610, using technology as disclosed in U.S. patent application Ser. No. 11/506,386. The backup device 600 comprises a communication interface 620, an emulation component 630, and a computer readable medium 640 that includes a first logical storage area 650 and second logical storage area 660. The computer readable medium 640 can be, for example, a hard disk drive (HDD) that has been partitioned into at least two logical storage areas. Other suitable computer readable media 640 are solid-state memory devices, such as Secure Digital (SD) memory cards and CompactFlash (CF) memory cards. The computer readable medium 640 can also be implemented by two different devices, one dedicated to each of the two logical storage areas 650, 660. In some embodiments, the backup device 600 further comprises a memory device interface 670 that allows the first and second logical storage areas 650 and 660 to communicate with the emulation component 630.

The first logical storage area 650 represents a logical area of the computer readable medium 640 that is meant to be inaccessible to the user and safe from accidental erasure. The first logical storage area 650 can contain, for example, a backup application, a look-up table, system files, drivers, and other setup and configuration software. The first logical storage area 650 is represented to the computing system 110 by the emulation component 630 as being an auto-launch device. As used herein, auto-launch devices are those devices that will trigger the automatic execution functionalities of certain operating systems, such as the AutoRun function of the Microsoft Windows operating system.

The second logical storage area 660 represents a logical area of the computer readable medium 640 that is dedicated to storing backed-up user settings. Accordingly, the emulation component 630 represents the second logical storage area 660 to the computing system 110 as being a writable computer readable medium. With reference to FIG. 1, where the backup device 100 more specifically comprises the backup device 600, the backup application can be launched automatically when the backup device 600 is connected to the computing system 110. The backup application can then perform a method described herein to back up a user setting to the second logical storage area 660.

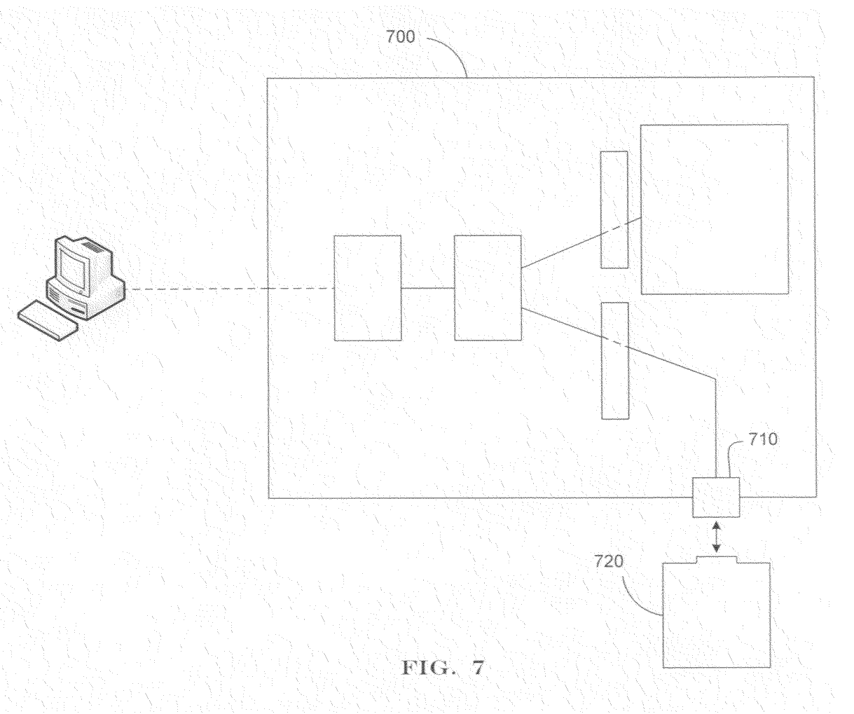

FIG. 7 shows a schematic representation of another exemplary backup device 700 similar to backup device 600 but without the second logical storage area 660 (FIG. 6). In place of the second logical storage area 660, the backup device 700 comprises a communication port 710 to allow a removable storage device 720, such as a SD or FC memory card or HDD, to be attached externally to the backup device 700. Thus, user settings can be backed up to the removable storage device 720.

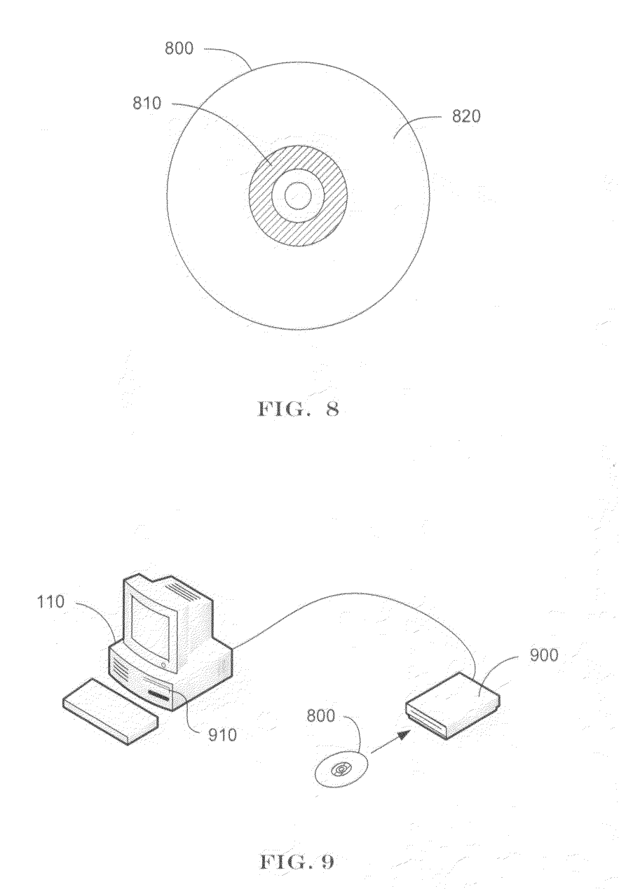

FIG. 8 shows a schematic representation of an exemplary backup device 800 using technology as disclosed in U.S. patent application Ser. No. 11/546,176. The backup device 800 comprises an optical disc having two portions, a read-only portion 810 and a writable portion 820. The portions 810, 820 can comprise either the same or different media formats. The read-only portion 810 includes computer-readable instructions for backing up user settings onto the writable portion 820. These computer-readable instructions can include, for example, a backup application.

FIG. 9 shows a computing system 110 connected to an external optical drive 900 for reading from and writing to the backup device 800. The computing system 110 can alternatively or additionally include an internal optical drive 910 for the same purpose. When the backup device 800 is inserted into either of the optical drives 900, 910, the operating system of the computing system 110 can automatically launch the backup application to then perform a method described herein to back up user settings to the writable portion 820 (FIG. 8).

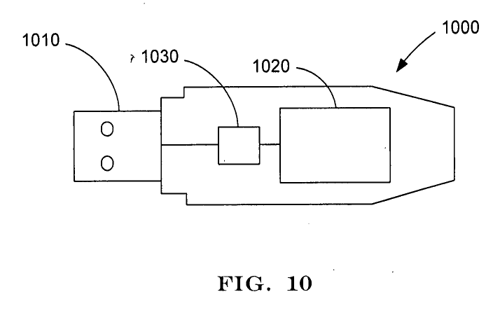

FIG. 10 shows a schematic representation of an exemplary backup device 1100 using technology as disclosed in U.S. patent application Ser. No. 11/601,040. The backup device 1000 comprises a USB interface 1010. The backup device 1000 can be, for example, a USB flash drive (UFD) such as a key drive, pen drive, jump drive, thumb drive, a memory stick, or the like. The backup device 1000 also comprises a flash memory 1020 and an emulation component 1030 in communication between the flash memory 1020 and the USB interface 1010. The flash memory 1020 includes computer-readable instructions comprising, for example, a backup application. The backup application, when executed, is configured to perform a method of the invention described herein to copy a user setting from a computing system 110 (FIG. 1) to, for example, the flash memory 1020 or to a networked storage (not shown). When the backup device 1000 is connected to a USB interface of the computing system 110, the operating system of the computing system 110 can recognize the backup device 1000 as an auto-launch device, because of the emulation component 1030, and automatically launch the backup application.

It will be appreciated that the Windows Vista operating system allows devices to designate themselves as auto-launching. The emulation components 630, 1030 in the backup devices 600, 700, and 1000 are therefore optional in those embodiments where these backup devices will be used with Windows Vista or some other operating system that provides similar functionality. In these embodiments, because the backup device can designate itself as auto-launching, the backup application can auto-launch.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method comprising:
searching a computing system to identify an application installed on the computing system;
obtaining a specified pathname for a user setting of the identified application; and
backing up the user setting of the identified application using the specified pathname.

2. The method of claim 1 wherein obtaining the specified pathname comprises accessing a look-up table.

3. The method of claim 1 wherein obtaining the specified pathname comprises obtaining the specified pathname from a backup device.

4. The method of claim 1 wherein obtaining the specified pathname comprises obtaining the specified pathname from a server.

5. The method of claim 1 wherein backing up the user setting includes storing the user setting to a backup device.

6. The method of claim 1 wherein backing up the user setting includes storing the user setting to a networked storage.

7. The method of claim 1 further comprising restoring to the computing system the backed up user setting using the specified pathname.

8. The method of claim 1 further comprising copying the user setting to another computing system.

9. The method of claim 1 further comprising receiving a selection of a user account and backing up the user setting includes using the selected user account.

10. The method of claim 1 further comprising obtaining a specified pathname for a user setting associated with an operating system of the computing system and backing up the user setting associated with the operating system.

11. The method of claim 1 further comprising obtaining a defined data field or a pathname for a Windows Registry key for a user setting of an operating system of the computing system and backing up the Windows Registry key of the user setting of the operating system using the defined data field or pathname for the Windows Registry key.

12. The method of claim 1 further comprising, after backing up the user setting, monitoring the user setting for a change thereto.

13. A method comprising:
searching a computing system to identify an application installed on the computing system;
obtaining a specified file extension for a user setting of the identified application; and
backing up the user setting of the identified application using the specified file extension.

14. The method of claim 13 wherein backing up the user setting includes storing an indication of a location of the user setting within a directory structure of the computing system.

15. A computer readable medium having stored thereupon computing instructions comprising:
a code segment to search a computing system to identify an application installed on the computing system;
a code segment to obtain a specified pathname for a user setting of the identified application; and
a code segment to back up the user setting of the identified application using the specified pathname.

16. A backup device comprising:
a computer readable medium having stored thereupon computing instructions including
a code segment to search a computing system to identify an application installed on the computing system;
a code segment to obtain a specified pathname for a user setting of the identified application; and
a code segment to back up the user setting of the identified application using the specified pathname.

17. The backup device of claim 16 wherein the code segment to back up the user setting is configured to back up the user setting to the computer readable medium.

18. The backup device of claim 16 wherein the computer readable medium comprises a hard disk.

19. The backup device of claim 16 wherein the computer readable medium comprises an optical disc.

20. The backup device of claim 16 wherein the computer readable medium comprises a flash memory.

21. The backup device of claim 16 further comprising an emulation component.
